(19) United States
(12) Patent Application Publication
(10) Pub. No.: US 2025/0242421 A1
(43) Pub. Date: Jul. 31, 2025

(54) COMBINED REAMER AND HONE TOOL

(71) Applicant: Van Norman Machine India PVT LTD, Chandigarh (IN)

(72) Inventors: Ranjit (Robin) CHERA, Chandigarh (IN); Sandeep CHERA, Chandigarh (IN)

(21) Appl. No.: 18/616,270

(22) Filed: Mar. 26, 2024

(30) Foreign Application Priority Data
Jan. 31, 2024 (IN) 202411006582

(51) Int. Cl. B23D 77/00

(52) U.S. Cl. CPC B23D 77/00

(57) ABSTRACT

A tool for performing combined reaming and honing operations is disclosed. The tool includes a shank, a centering section positioned at a distal end of the shank, a reaming zone positioned proximity to the centering section, and a honing zone positioned proximity to the reaming zone. The shank connects to a machine via an adapter. The shank axially advances into a workpiece to be precision surfaced while rotating and reciprocating relative to the workpiece to be precision surfaced. The centering section centers and aligns the tool with the workpiece such that the workpiece comes in contact with the reaming zone followed by the honing zone. The reaming zone removes a stock of material from the workpiece and the honing zone removes the stock of said material for precision surface in the workpiece.

### CROSS-REFERENCE TO RELATED APPLICATION

This application is based upon and claims priority from, Application No. IN202411006582, filed on 31 Jan. 2024 the entireties of both of which are incorporated herein by reference for all purposes.

### FIELD OF THE INVENTION

The present invention generally relates to machine tools. More particularly, the present invention relates to a tool for performing reaming and honing operations on a workpiece with a high precision surface.

### DESCRIPTION OF THE RELATED ART

As known, reaming and honing are different processes used to improve the internal geometry and surface finish of holes in a workpiece or guide valve. Typically, reaming involves placing a reamer tool having cutting edges in the hole of the workpiece and removing a small amount of material to achieve the desired size and finish. Honing involves placing a honing tool made of abrasive material to improve the geometric form, size and surface finish of the hole in the workpiece. In the honing process, the precision surface is achieved by scrubbing an abrasive grinding wheel or abrasive grinding stone against the workpiece along a controlled path.

A reamer tool and/or a honing tool are used manually or with an automatic honing machine to produce desired characteristics on the workpiece, however they have been used separately to perform the required operation. Several tools that combine two operations have been proposed in the past. One such tool is disclosed in a United States Publication No. 20130058734, entitled “Combined drill and reamer tool” (“the '734 Publication”). The '734 Publication discloses a drill-reamer tool comprising a shank portion and a cutting portion coaxial with the shank portion, the cutting portion having an operational portion comprising at least one twist drill spiral roughing cutting edge associated with a land margin, a land clearance and a flute. The cutting portion further comprises at least one spiral finishing edge interlaced with the spiral roughing cutting edge and having associated therewith only a land margin and a flute. The land margin of said finishing edge being provided with a plurality of reamer cutting edges spiraling in an opposite direction to that of the roughing cutting edge. The reamer cutting edges are configured to cut a larger hole than said roughing edge. The operational portion being dimensioned such that during operation, both the roughing cutting edge and the reamer cutting edge are simultaneously operative.

Another example is disclosed in a PCT Publication No. 2017115332 entitled “Reamer-drill bit for drilling and smoothing a hole in a component carrier” (“the '332 Publication”). The '332Publication discloses a reamer-drill bit for drilling and smoothing a hole in a component carrier, wherein the reamer drill bit comprises a front drill section for drilling the hole in the component carrier, wherein the front drill section comprises a drilling tip and at least three cutting edges spaced apart from each other along a drilling rotation direction, wherein the cutting edges comprise at least one component extending from the drilling tip along a rotational axis of the reamer-drill bit, and a rear reamer section for smoothing the hole, wherein the rear reamer section extends from the front drill section along the rotational axis.

Although the disclosures presented above are useful, they cannot be used for performing both reaming and honing operations in a valve guide or workpiece. In a typical reaming and honing operation, it is important to position the hole to a certain extent such that reaming can be performed before final machining (honing) can be performed to achieve the required surface finish in the workpiece. Typically, separate tools are used to perform reaming and honing operations, which is time consuming and generates a lot of tool wastage. For example, three separate and progressive tools (one for roughing, one for semi-finishing and one for honing) might be required to remove 200 microns of material from the workpiece. Further, it is not possible to achieve accurate surface finish in the workpiece. Furthermore, if the workpiece is longer, then reaming and honing operations performed separately may result in irregular shape or surface finish.

Therefore, there is a need in the art to provide a tool that combines reaming and honing operations and achieves a high degree of precision surface finish.

### SUMMARY

It is one of the main objects of the present invention to provide a tool that combines reaming and honing operations and that avoids the drawbacks of the prior art.

It is another object of the present invention to provide a tool capable of combining reaming and honing operations in order to drill a hole, ream solid material from the hole and provide required surface finish in one production pass, reducing setup time and cost per operation.

It is another object of the present invention to provide a tool that achieves a much higher surface finish with a single tool instead of multiple different tools as in the prior art.

In order to overcome the limitations here stated, the present invention provides a tool or cylinder head guide finishing tool for performing combined reaming and honing operations. The tool includes a shank, a centering section positioned at a distal end of the shank, a reaming zone positioned proximity to the centering section, and a honing zone positioned proximity to the reaming zone. The reaming zone has an end mill section and a reaming section. The end mill section and the reaming section are configured to remove 0.250 millimetre of the stock of material from a workpiece.

The honing zone includes a first honing zone and a second honing zone. The second honing zone has a fine grit diamond than the first honing zone. The first honing zone has a medium grit diamond and removes the stock of material of about 0.02 millimetre from the workpiece. The second honing zone has a fine grit diamond and removes the stock of material of about 0.0008 millimetre from the workpiece for precision surface in the workpiece.

In operation, the shank connects to a machine via an adapter. The centering section centers and aligns the tool with the workpiece. The shank axially advances towards an area on a workpiece to be precision surfaced while rotating and reciprocating relative to the workpiece such that the workpiece comes in contact with the reaming zone followed by the honing zone. The reaming zone removes a stock of material from the workpiece and the honing zone removes the stock of said material for precision surface in the workpiece.

In one advantageous feature of the present invention, the reaming section removes 0.250 millimetre of the stock of material. Further, the honing zone removes the stock of material of about 0.0008 millimetre from the workpiece for precision surface in the workpiece.

In another advantageous feature of the present invention, the tool combines both reaming and honing operations in order to mill a hole, ream solid material from the hole and provide required surface finish in one production pass, reducing setup time and cost per operation.

In yet another advantageous feature of the present invention, the tool having the centering section, the reaming zone and the honing zone are conditioned to the exact size for providing required surface finish. In other words, the centering provides guide alignment and helps the reaming zone and the honing zone to be conditioned to the exact size for providing required surface finish. This ensures the users need not have to do any adjustment.

In yet another advantageous feature of the present invention, the tool helps to center itself and with one touch of a button or command and automatically removes 200 microns and hones the guide with 2 microns' accuracy. The tool is made of a carbide material and configured to perform two operations in a single setup. When compared with prior art that require three separate and progressive tools (one for roughing, one for semi-finishing and one for honing) for removing, say 200 microns of material from the workpiece), the presently disclosed tool incorporates geometry of all three tools for removing 200 microns with 2 microns' accuracy.

Features and advantages of the invention hereof will become more apparent in light of the following detailed description of selected embodiments, as illustrated in the accompanying FIGUREs. As will be realized, the invention disclosed is capable of modifications in various respects, all without departing from the scope of the invention. Accordingly, the drawings and the description are to be regarded as illustrative in nature.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 illustrates an environment in which a tool for combining reaming and honing operations implements, in accordance with one embodiment of the present invention;

FIG. 2 illustrates the tool, in accordance with one embodiment of the present invention;

FIG. 3, FIG. 4 and FIG. 5 illustrate the tool axially advancing progressively into a workpiece, in accordance with one embodiment of the present invention; and

FIG. 6 illustrates a display presenting options to operate a machine for performing combined reaming and honing operations, in accordance with one embodiment of the present invention.

### DESCRIPTION OF THE EMBODIMENTS OF THE INVENTION

The following detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed tool. However, it will be apparent to those skilled in the art that the presently disclosed invention may be practiced without these specific details. In some instances, well-known structures and devices are shown in functional or conceptual diagram form in order to avoid obscuring the concepts of the presently disclosed tool.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention provides a description of a tool, it is to be further understood that numerous changes may arise in the details of the embodiments of the apparatus. It is contemplated that all such changes and additional embodiments are within the spirit and true scope of this disclosure.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

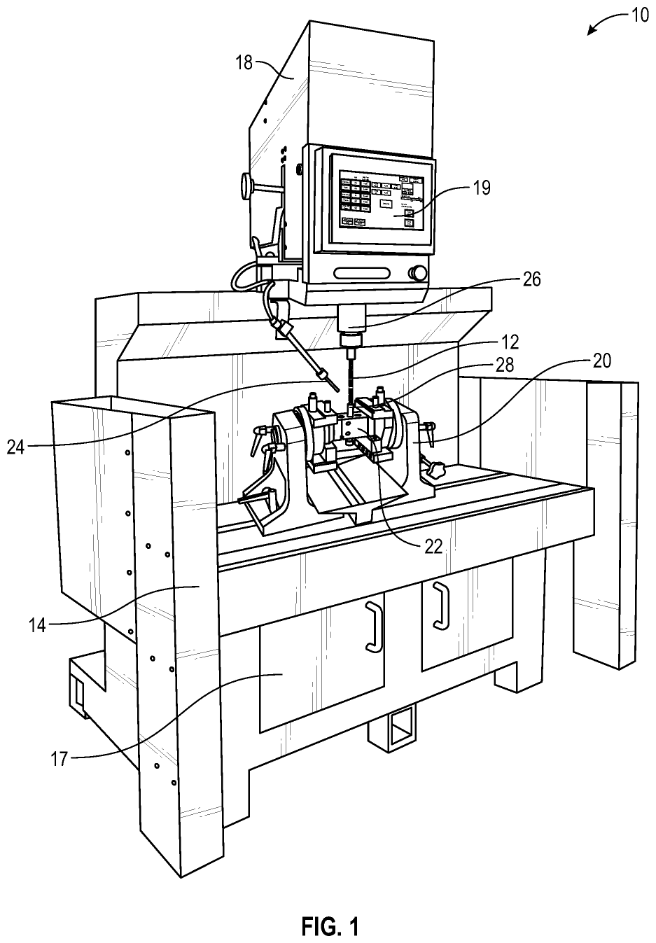

Various features and embodiments of a tool for performing reaming and honing operations are explained in conjunction with the description of FIGS. 1-6.

Referring to FIG. 1, an environment 10 in which a combined reaming and honing tool or cylinder head guide finishing tool 12 implements is shown, in accordance with one embodiment of the present invention. For ease of reference, combined reaming and honing tool 12 is referred as tool 12 hereinafter. Tool 12 is used for performing both reaming and honing operations with a single device or tool. As known, reaming operation is performed to remove the irregularities (irregular shape) in a workpiece i.e., a drilled hole and making it perfectly round. Further, honing is performed to achieve a surface finish that gives a very smooth inner surface usually required for frictionless relative motion between two parts.

In the present invention, a machine 14 is used to hold tool 12 for performing both reaming and honing operations. In one example, machine 14 indicates a guide honing machine used for performing both reaming and honing operations. Machine 14 includes a housing 17 at the bottom. Further, machine 14 includes a work head 18 at the top of housing 17. Work head 18 encompasses a display or operational panel 19. Operational panel 19 is configured to provide instructions to operate tool 12 to perform each of reaming and honing operations. As can be seen from FIG. 1, housing 17 includes fixtures 20 having guide receiving sections 22. Guide receiving sections 22 indicate arms extending from fixtures 20 and configured for holding a workpiece or valve guide 28. Further, machine 14 includes a coolant arm 24 extending from work head 18. Coolant arm 24 is positioned to dispense coolant 29 on to workpiece 28 when machine 14 is in operation, as shown in FIG. 4, for example. Furthermore, machine 14 includes a tool holder or spindle 26 extending downward from work head 18. Here, tool holder 26 is configured to hold and rotate tool 12 for performing reaming and honing operations.

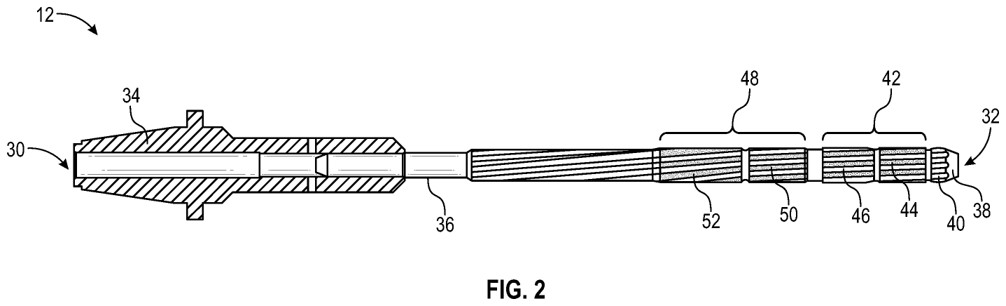

FIG. 2 shows a partial cross-sectional view of tool 12, in accordance with one embodiment of the present invention. Tool 12 includes a first end 30 and a second end 32. Tool 12 includes an adapter 34. Adapter 34 connects to tool holder 26 and helps to operate tool 12 in reciprocal and rotational motions for performing reaming and honing operations in workpiece 28. Tool 12 includes a shank or cylindrical body or arbor 36. Shank 36 comes in a cylindrical configuration. In one example, shank 36 has a tapered configuration. A person skilled in the art understands that shank 36 can have a single taper or multiple tapers at one or both ends depending on the need. Shank 36 is made of a suitable material such as a premium grade carbide material or hardened or unhardened steel. Shank 36 includes a head or headstock that connects to adapter 34.

At second end 32, shank 36 encompasses a tip 38. Tip 38 has a tapered configuration. Further, shank 36 encompasses a centering section 40. Centering section 40 has a tapered configuration extending from a cylindrical configuration with smooth surface. Centering section 40 acts as a centering and aligning section for tool 12. Centering section 40 helps to align shank 36 at center and hone workpiece 28. In other words, centering section 40 aligns the axis of spindle or tool holder 24 with workpiece or valve guide 28.

Further, shank 36 includes a reaming zone 42. Reaming zone 42 positions adjacent to centering section 40. Reaming zone 42 includes a plurality of reamer cutting edges spiralling in an opposite direction to that of a roughing cutting edge. Reaming zone 42 includes an end mill section or shell mill reamer 44 and a reaming section 46. End mill section 44 is configured to cut on the periphery i.e., outer edge and the end (bottom) of workpiece 28. End mill section 44 helps to remove material in a horizontal direction as end mill section 44 has a flat surface (flat cutting edge) facing centering section 40. As a result, end mill section 44 helps to keep tool 12 perpendicularly with respect to workpiece 28. Further, end mill section 44 creates its own centre and straightens workpiece 28 axis and makes bore geometry perpendicular to tool holder 24 axis. In other words, end mill section 44 performs a roughing operation on workpiece 28. End mill section 44 has a substantially cylindrical configuration and has a slightly larger diameter than centering section 40. This helps to achieve centering of tool 12 in workpiece 18 and also to mill a hole in workpiece 18.

Reaming section 46 positions adjacent to end mill section 44. In the present invention, reaming section 46 is configured to enlarge and finish a hole in workpiece 28 to a precise diameter. Reaming section 46 performs a reaming operation in order to create better surface finish and better bore geometry. As specified above, reaming zone 42 has spiralling reamer cutting edges. Further, reaming zone 42 has a substantially cylindrical configuration with a tapered end facing end mill section 44. Further, reaming zone 42 has a slightly larger diameter than end mill section 44 in to remove material from workpiece 18. In the present invention, reaming zone 42 is designed to remove a small amount of material say up to 0.250 millimeter (mm) to achieve the desired hole size in workpiece 28.

Still referring to FIG. 2, shank 36 includes a honing zone 48. Honing zone 48 positions adjacent to reaming section 46. In accordance with the present invention, honing zone 48 includes a first honing zone 50 and a second honing zone 52. First honing zone 50 positions adjacent to reaming section 46 and second honing zone 52 positions adjacent to first honing zone 50. Each of first honing zone 50 and second honing zone 52 consists of a diamond abrasive boring bar which is constructed from an expandable soft cast iron sleeve permanently coated with grit of natural diamond abrasive or constructed with a sintered sleeve which has abrasive embedded in it. In accordance with the present invention, first honing zone 50 presents a semi-finish honing zone or medium honing section with a medium grit diamond. In one implementation, first honing zone 50 is integrated with shank 36. In another implementation, first honing zone 50 is provided as a sleeve or plate over shank 36. First honing zone 50 is made of natural and synthetic diamonds, premium grade carbide material or hardened or unhardened steel, cubic boron nitrides, and superabrasives, of appropriate hardness, friability, compatibility and other characteristics for particular applications. First honing zone 50 has a first tapered section facing inwards/towards shank 36 (at the side facing reaming section 46). In one example, the first tapered section is tapered to align with the outer diameter of reaming section 46. Here, first honing zone 50 has a substantially cylindrical configuration and has a slightly larger diameter than reaming section 46. This helps to provide a smoother finish over the material removed by reaming section 46.

Second honing zone 52 presents a final finish honing zone or fine honing section with a fine grit diamond. Second honing zone 52 is provided as a sleeve or plate over shank 36. Second honing zone 52 is made of natural and synthetic diamonds, premium grade carbide material or hardened or unhardened steel, cubic boron nitrides, and superabrasives, of appropriate hardness, friability, compatibility and other characteristics for particular applications. Second honing zone 52 includes a tapered section that is tapered inwards/towards shank 36. In one example, the tapered section on second honing zone 52 aligns with the outer diameter of first honing zone 50.

In one embodiment, each of reaming zone 42 and honing zone 48 has an incremental diameter with respect to centering section 40. The incremental diameter helps to obtain required centering and surface finish when reaming zone 42 and honing zone 48 come in contact with workpiece 28. In one example, reaming zone 42 and honing zone 48 are provided with an incremental diameter of say 0.1 or 0.01 millimetre than centering section 40. Reaming zone 42 and honing zone 48 are provided with incremental diameter to achieve greater or near zero alignment of tool 12 and workpiece 28.

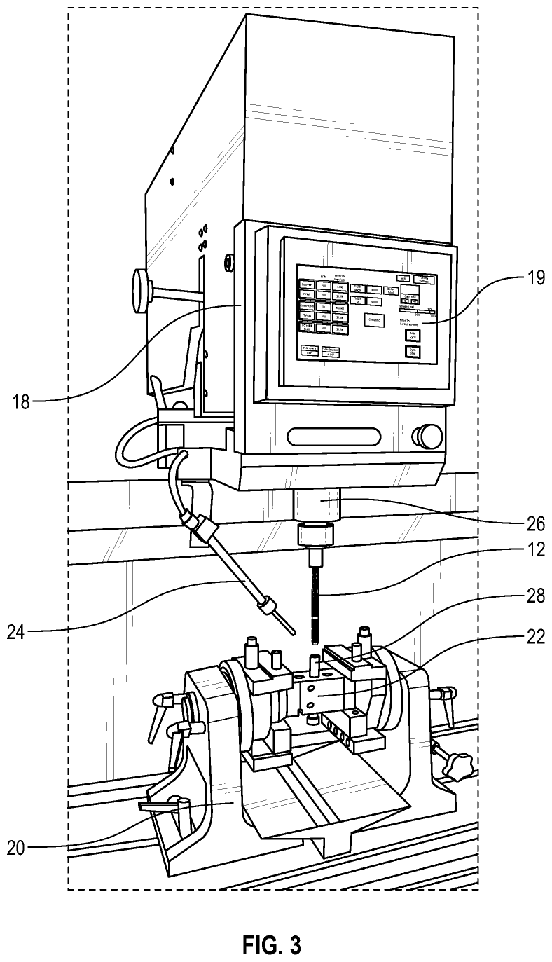

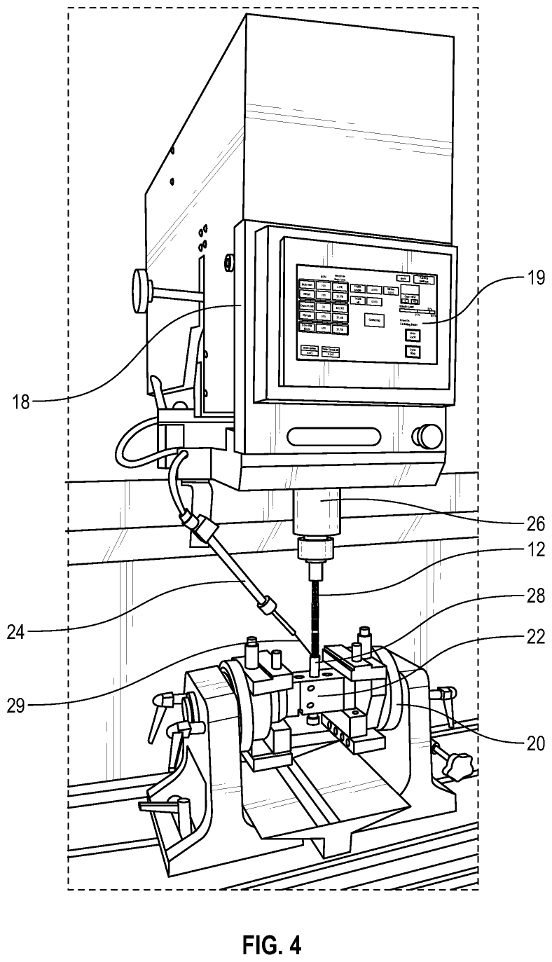

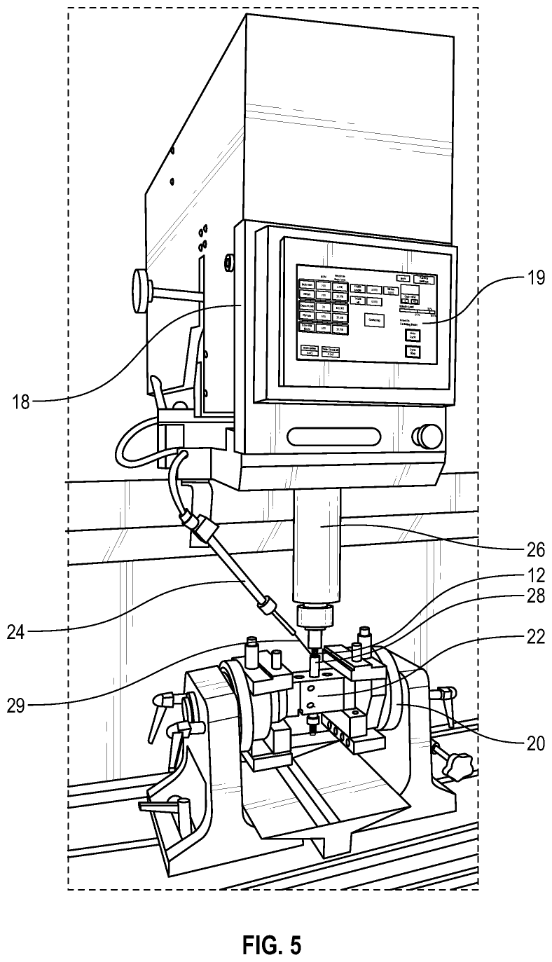

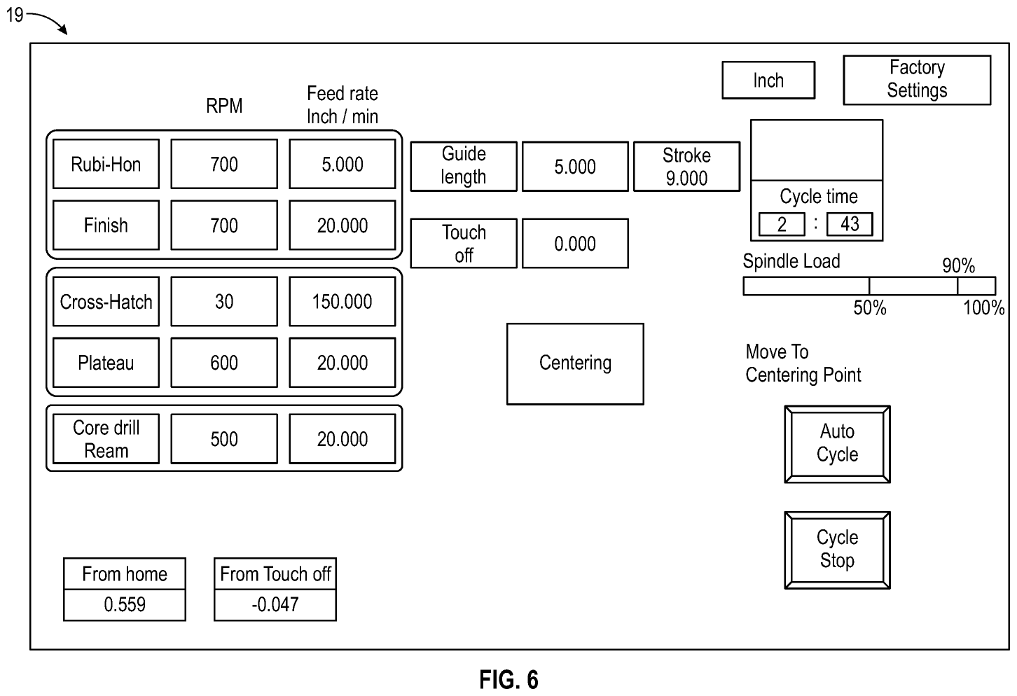

Now referring to FIG. 3, FIG. 4, FIG. 5 and FIG. 6, the operation of machine 14 for performing both reaming and honing operations is explained, in accordance with one embodiment. At first, an operator selects options on display 19 to determine parameters for performing reaming and honing operations with tool 12. First, the operator determines the parameters for centering tool 12. Further, the operator determines the speed i.e., rotations per minute for tool holder 24. Further, the operator determines the length of workpiece/valve guide 28. Further, the operator determines the feed rate per min for reaming zone 42 and honing zone 48. FIG. 3 shows the feature of tool 12 positioning above workpiece 28. After placing tool 12, machine 14 is operated manually to position tip 38 in workpiece 28. Subsequently, machine 14 is operated in a centering cycle. In accordance with the present invention, machine 14 is configured to operate in the centering cycle, followed by reaming cycle and honing cycle. In the centering cycle, machine 14 centers and aligns tool 12 with respect to workpiece 28. In the reaming cycle, machine 14 is configured to remove stock material from workpiece 28. In the honing cycle, machine 14 is configured to hone the bore with required surface finish in workpiece 28.

As specified above, machine 14 is operated manually to position tip 38 in workpiece 28. In one example, the operator selects a plateau option on display 19 and manually adjusts the position of tip 38 and advances tool 12 such that centering section 40 enters workpiece 28. After positioning centering section 40, machine 14 is initiated to operate in the centering cycle. Here, machine 14 advances tool 12 such that centering section 40 centers itself and aligns with respect to workpiece 28. Concurrently or consecutively, machine 14 is operated in an automated cycle. Operating machine 14 causes tool 12 to rotate and reciprocate relative to workpiece 12. Simultaneously, machine 14 dispenses coolant 29 via coolant arm 28 onto workpiece 12. As tool 12 advances into workpiece 12, end mill section 44 comes into contact with workpiece 12 initiating reaming cycle, as shown in FIG. 4, for example. During the reaming cycle, end mill section 44 and reaming section 46 come in contact with workpiece 28 and remove material from workpiece 28. Subsequently, tool 12 moves up or retracts up to the height of tool centering to remove the chips away from workpiece 28. In one example, reaming zone 42 having end mill section 44 and reaming section 46 are configured to remove material of up to 0.250 mm from workpiece 12. For example, end mill section 44 removes 0.150-0.200 mm and reaming section 46 removes 0.050-0.100 mm.

After removing the material, tool 12 advances further such that honing zone 48 comes in contact with workpiece 28 thereby initiating a honing cycle. During the honing cycle, first honing zone 50 and second honing zone 52 come in contact with workpiece 12 and hone workpiece 28 for providing required surface finish in workpiece 28, as shown in FIG. 5. In one example, first honing zone 50 helps to remove up to 0.0007″ (0.02 mm) of material from workpiece 28. In other words, first honing zone 50 helps to achieve a surface finish of 0.002 mm bore accuracy automatically. Further, second honing zone 52 helps to remove up to 0.0003″ (0.008 mm) of material from workpiece 28. Removal of up to 0.0003″ material helps to achieve surface finish of approximately 0.1 Ra M for workpiece 28. Subsequently, tool 12 moves up or retracts up to the height of tool centering to remove microchips away from workpiece 28. Optionally, honing zone 48 includes a third honing zone (not shown) positioned adjacent to second honing zone 52. The third honing zone has a much smaller grit and enables it to preserve tool 12 for a longer period of time by allowing it to be used upon wearing off of second honing zone 52 and/or first honing zone 50.

When compared with traditional tools, machine 14 has to be fitted with three or four tools, each for end mill machining, reaming operation and honing operation to remove the material and hone workpiece 28 to achieve surface finish of approximately 0.1 Ra M for workpiece 28. With the presently disclosed tool 12, machine 14 requires a single tool to achieve surface finish of approximately 0.1 Ra M for workpiece 28. This results in sustainability in removing the material from workpiece 28.

A person skilled in the art understands that tool 12 achieves surface finish within 0.002 mm bore accuracy. The precision surface together with guide alignment and reaming operation presents a unique combined centering cycle, reaming cycle and honing cycle that produce required surface finish. This enables tool 12 to precision surface (Nano precision ground) and condition to exact diameter to hone.

It should be understood that the tool presents a fast and accurate method of sizing certain bores to final size i.e., fine grit (second honing zone). The abrasive zones mounted on the shank/arbor are expandable. For instance, the zone(s) is expanded to size during the setup. Further, the shank is pushed through the bore only once. If required, only periodic expansion adjustments are necessary to compensate for tool wear after initial setup. The tool is used depending on the types and volumes of material that can be removed. The size and volume of chips removed should be no more than there is clearance between the grit diamonds on the zone. Therefore, the presently disclosed tool is best suited for reaming and honing operations that produce a relatively low volume of chips, such as interrupted or short bores, and is most successful in honing cast iron and powdered metals.

Although the above description is explained considering that there are three different zones (end mill section, reaming section and honing zone), it is possible to implement the invention with two zones such as reaming section 46 and honing zone 48. In such implementation, reaming section 46 removes a majority of stock of material. Further, honing zone 48 removes the stock of material and provides precision surface. Such an implementation falls within the scope of the present invention.

The present invention provides several advantages over the prior art. The presently disclosed shank is made of carbide material, which is known to be the hardest material for maintaining straightness and long life. The tool is conditioned to the exact size for removing material and providing finish honing together with alignment of the workpiece. This ensures the users need not have to do any adjustment prior or during the operation of the reaming and honing cycles. Further, the presently disclosed tool is capable of achieving a surface finish within 0.002 mm bore accuracy automatically. The precision is achieved with a single tool capable of operating in both reaming and honing cycles. This when compared with three or four tools used separately in the prior art presents an advanced combinational tool that allows to avoid a lot wastage of material thereby enhancing sustainability.

A person skilled in the art appreciates that the tool may come in a variety of shapes and sizes depending on the need and comfort of the user. Further, many changes in the design and placement of components may take place without deviating from the scope of the presently disclosed tool.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

What is claimed is:

1. A tool for performing reaming and honing operations, said tool comprising:
a shank;
a centering section positioned at a distal end of said shank,
a reaming zone positioned proximity to said centering section; and
a honing zone positioned proximity to said reaming zone,
wherein said shank connects to a machine via an adapter, wherein said shank axially advances into a workpiece to be precision surfaced while rotating and reciprocating relative to said workpiece, wherein said centering section centers and aligns said tool with said workpiece such that said workpiece comes in contact with said reaming zone followed by said honing zone, and wherein said reaming zone removes a stock of material from said workpiece and said honing zone removes the stock of said material for precision surface in said workpiece.

2. The tool of claim 1, wherein said reaming zone has an end mill section and a reaming section.

3. The tool of claim 2, wherein said end mill section positions adjacent to said centering section, and wherein said reaming section positions adjacent to said end mill section.

4. The tool of claim 2, wherein said end mill section and said reaming section remove about 0.250 millimetre of the stock of material from said workpiece.

5. The tool of claim 1, wherein said honing zone comprises a first honing zone and a second honing zone, and wherein said second honing zone has a fine grit diamond than said first honing zone.

6. The tool of claim 4, wherein said first honing zone positions adjacent to said reaming section and comes in contact with said workpiece followed by said second honing zone when said shank axially advances towards said workpiece.

7. The tool of claim 6, wherein said first honing zone has a medium grit diamond and removes the stock of material of about 0.02 millimetre from said workpiece, and wherein said second honing zone has a fine grit diamond and removes the stock of material of about 0.008 millimetre from said workpiece for precision surface on said workpiece.

8. The tool of claim 1, wherein said centering section, said reaming zone and said honing zone are spaced apart at a distance from one another.

9. The tool of claim 1, wherein said reaming zone has a larger diameter than said centering section, and wherein said honing zone has a larger diameter than said reaming zone.

10. The tool of claim 5, wherein each of said reaming section and said first honing zone comprises a tapered section, and wherein each of said tapered sections facilitates aligning an axis of said tool with said workpiece.

11. A tool for performing reaming and honing operations, said tool comprising;
a shank;
a reaming zone positioned at substantially proximity to a distal end of said shank; and
a honing zone positioned at substantially centre of said shank and in proximity to said reaming zone;
wherein said shank connects to a machine via an adapter, wherein said shank axially advances into a workpiece to be precision surfaced while rotating and reciprocating relative to said workpiece, wherein said shank axially advances such that said workpiece comes in contact with said reaming zone followed by said honing zone, and wherein said reaming zone removes a stock of material from said workpiece and said honing zone removes the stock of said material for precision surface in said workpiece.

12. The tool of claim 11, further comprises a centering section, wherein said centering section positioned between said distal end and said reaming zone.

13. The tool of claim 12, wherein said centering section centers and aligns said tool with respect to said workpiece.

14. The tool of claim 11, wherein said reaming zone has an end mill section and a reaming section, wherein said end mill section positions adjacent to said centering section, and wherein said reaming section positions adjacent to said end mill section.

15. The tool of claim 14, wherein said end mill section and said reaming section remove 0.250 millimetre of the stock of material from said workpiece.

16. The tool of claim 11, wherein said honing zone comprises a first honing zone and a second honing zone, and wherein said second honing zone has a fine grit diamond than said first honing zone.

17. The tool of claim 16, wherein said first honing zone positions adjacent to said reaming section and comes in contact with said workpiece followed by said second honing zone when said shank axially advances towards said workpiece.

18. The tool of claim 17, wherein said first honing zone has a medium grit diamond and removes the stock of material of about 0.02 millimetre from said workpiece, and wherein said second honing zone has a fine grit diamond and removes the stock of material of about 0.0008 millimetre from said workpiece for precision surface on said workpiece.

19. The tool of claim 12, wherein said reaming zone has a larger diameter than said centering section, and wherein said honing zone has a larger diameter than said reaming zone.

20. A method of providing a tool for performing reaming and honing operation, said method comprising the steps of;
providing a shank;
providing a centering section positioned at a distal end of said shank;
providing a reaming zone positioned proximity to said centering section;
providing a honing zone positioned proximity to said reaming zone;
connecting said shank to a machine via an adapter;
axially advancing said shank into a workpiece to be precision finished while rotating and reciprocating relative to said workpiece to be precision surfaced;
centering and aligning said centering section of said shank with said workpiece such that said workpiece comes in contact with said reaming zone followed by said honing zone; and
removing a stock of material using said reaming zone and said honing zone from said workpiece for precision surface in said workpiece.
